(19) United States
(12) Patent Application Publication
(10) Pub. No.: US 2004/0189808 A1
(43) Pub. Date: Sep. 30, 2004

(54) Host/function apparatus

(75) Inventor: Hiroshi Tanaka, Aasaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/768,921

(22) Filed: Feb. 2, 2004

(30) Foreign Application Priority Data
Mar. 24, 2003 (JP) 080592/2003

(51) Int. Cl. H04N 5/225

(52) U.S. Cl. 348/207.1

(57) ABSTRACT

Connections among a host device such as a personal computer, a function device such as a digital camera, and a host/function apparatus that operates both as a host device and a function device, such as a printer, are enabled without disconnecting and reconnecting cables. A digital camera, a printer and a personal computer are connected with USB cables. The printer is enabled to switch operating modes among: a camera connection mode, in which it connects to the digital camera; a PC connection mode, in which it connects to the personal computer; and a pass through mode, in which the digital camera and the personal computer are connected to each other.

### BACKGROUND OF THE INVENTION

1. Field of the Invention

The present invention relates to a host/function apparatus which is connected to a host device such as a personal computer and a function device such as a digital camera via USB cables, for example. The host/function apparatus operates as a host device or a function device, depending on the apparatuses connected thereto.

2. Description of the Related Art

Conventionally, peripheral devices such as digital cameras and printers are connected to personal computers. Images obtained by the digital camera are transmitted to the personal computer, and are printed by the printer. The USB (Universal Serial Bus) standard is employed to connect personal computers with peripheral devices, due to its ease in connection. A system for printing images obtained by a digital camera is proposed in Japanese Unexamined Patent Publication No. 2001-238105. In this system, a digital camera 1, a printer 2, and a personal computer 3 are connected to each other via USB cables 5 and 6, as shown in FIG. 6. Images obtained by the digital camera 1 are transmitted to the personal computer 3, and are printed by the printer 2. In this system, the personal computer 3 operates as a host device, while the digital camera 1 and the printer 2 operate as function devices.

So-called “direct printing” systems are proposed in U.S. Pat. No. 6,549,958 and Japanese Unexamined Patent Publication No. 2001-290612. In these direct printing systems, a digital camera is directly connected to a printer, without the intermediary of a personal computer. The printer prints images, which have been obtained by the digital camera by photography. In these direct printing systems, the printer operates as a host device, and the digital camera operates as a function device. Further, in the case that the camera is directly connected to the printer, a personal computer 3 may be connected to the printer 2 as shown in FIG. 1. In this configuration, the personal computer 3 may operate as a host device for controlling the printer 2, which operates as a function device, to perform printing.

However, in the system disclosed in Japanese Unexamined Patent Publication No. 2001-238105, when the personal computer is turned off, the connections with the printer and the digital camera are also cut off. Therefore, in order to operate the printer from the digital camera, it becomes necessary to disconnect the USB cable from the personal computer and reconnect it to the printer. In the system shown in FIG. 1, if the printer is turned off, the connections with the personal computer and the digital camera are also cut off. Therefore, in order to transmit images from the digital camera to the personal computer, it becomes necessary to disconnect the USB cable from the printer and reconnect it to the personal computer. It is often the case that personal computers and printers are set against walls. It is also often the case that cable connectors are provided at the rear sides of personal computers and printers. Therefore, the disconnecting and reconnecting of cables is extremely troublesome. In particular, the shapes of USB cable connectors differ between that for a host device and that for a function device. Accordingly, confirmation of the shape of the connector is added to the disconnecting and reconnecting operation, further adding to the trouble.

It is conceivable to prepare another cable and to keep the digital camera and the printer, or the digital camera and the personal computer connected. However, this approach is not favorable, as the cost of the cable becomes a burden on a user.

### SUMMARY OF THE INVENTION

The present invention has been developed in view of the circumstances described above. It is the object of the present invention to connect a host device such as a personal computer, a function device such as a digital camera, and a host/function apparatus that operates both as a host device and a function device, such as a printer, without disconnecting and reconnecting cables.

The host/function apparatus according to the present invention operates as both a host device and a function device, and comprises:

a first connector, to which a host device is connected via a first cable;

a second connector, to which a function device is connected via a second cable; and

a mode switching means for switching operating modes among a host mode, in which the apparatus operates as a host device, a function mode, in which the apparatus operates as a function device, and a pass through mode, in which the first connector and the second connector are connected.

Note that a configuration may be adopted wherein:

the mode switching means switches to the pass through mode when the host/function apparatus is turned off.

In addition, a configuration may be adopted wherein:

the shapes of the first connector and the second connector differ.

In this case, the first connector and the second connector may be USB connectors.

Further, a configuration may be adopted wherein:

the host device is a data processing device;

the function device is a digital camera; and

the host/function apparatus further comprises an output means for printing images according to commands from the data processing device, as well as for printing images recorded in the digital camera.

Note that it is possible to connect a plurality of host/function apparatuses according to the present invention. In this case, a host device is connected to the host/function apparatus at one end of the connection, and a function device is connected to the host/function apparatus at the other end of the connection.

According to the present invention, the mode switching means switches the operating mode of the host/function apparatus among a host mode, in which the apparatus operates as a host device, a function mode, in which the apparatus operates as a function device, and a pass through mode, in which the first connector and the second connector are connected. In the host mode, the host/function apparatus operates as a host device, connected to the function device via the second connector. In the function mode, the host/function apparatus operates as a function device, connected to the host device via the first connector. In the pass through mode, the first connector and the second connector are connected. Therefore, the host/function apparatus operates merely as a hub, via which the host device and the function device are connected. Accordingly, the host device, the function device, and the host/function apparatus according to the present invention can be connected without disconnecting and reconnecting the first and second cables that connect them.

A configuration may be adopted wherein the mode switching means switches to the pass through mode when the host/function apparatus is turned off. Thereby, the host device and the function device can be connected without turning the host/function apparatus on, which saves electricity.

In the case that the shapes of the first connector and the second connector differ, it becomes necessary to confirm the shapes of the connector during the disconnecting and reconnecting operation. This causes the operation to become extremely troublesome. However, according to the present invention, the necessity of the disconnecting and reconnecting operation is obviated. Therefore, even in the shapes of the first connector and the second connector differ, confirmation of the shapes thereof becomes unnecessary.

In the case that the host device is a data processing device such as a personal computer, the function device is a digital camera, and the host/function apparatus according to the present invention is a printer, the direct printing system described above can be realized by switching the mode switching means to the host mode.

### BRIEF DESCRIPTION OF THE DRAWINGS

FIG. 1 is a schematic view of a printing system in which a printer, which is an embodiment of the host/function apparatus of the present invention, is employed.

FIG. 2 is a plan view of a mode switch.

FIG. 3 is a block diagram of the signal processing system of the printer.

FIG. 4A, FIG. 4B, and FIG. 4C are diagrams that show the states, corresponding to operating modes, of a switch portion.

FIG. 5 is a schematic view of a printing system in which a printer, which is another embodiment of the host/function apparatus of the present invention, and an MO disk drive, is employed.

FIG. 6 is a schematic view of a conventional printing system.

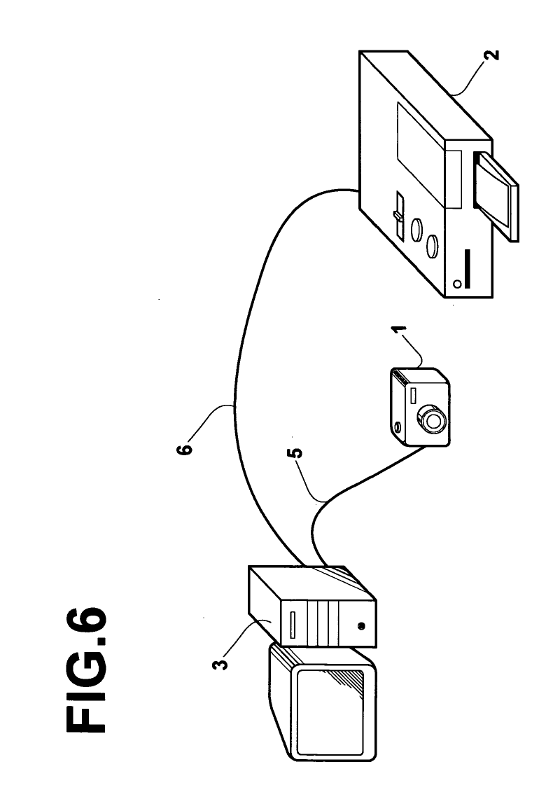

### DESCRIPTION OF THE PREFERRED EMBODIMENTS

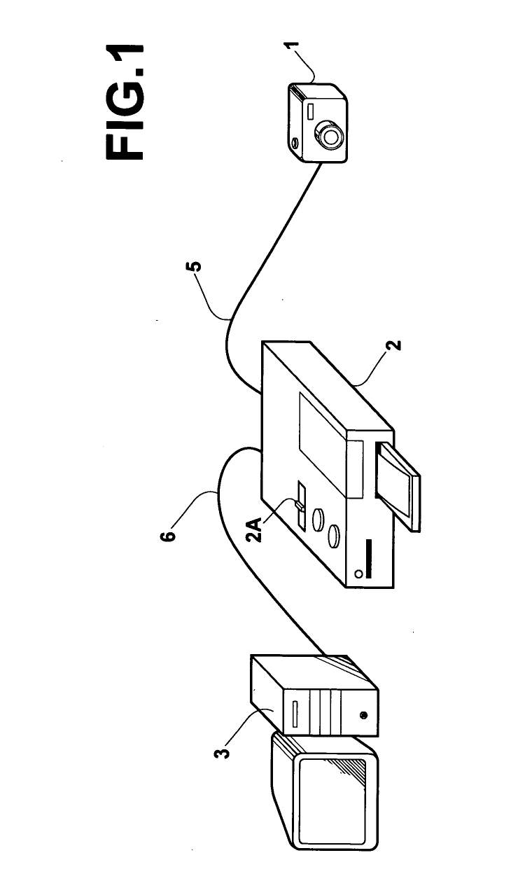

Hereinafter, embodiments of the present invention will be described with reference to the attached drawings. FIG. 1 is a schematic view of a printing system in which a printer, which is an embodiment of the host/function apparatus of the present invention, is employed. As shown in FIG. 1, the printing system of the present embodiment comprises a digital camera 1, a printer 2, and a personal computer 3. The digital camera 1 and the printer 2 are connected by a first USB cable 5, and the printer 2 and the personal computer 3 are connected by a second USB cable 6.

Here, the digital camera 1 always operates as a USB function device. In the case that the printer 2 operates as a USB host device, a direct printing function, wherein images recorded in a memory card of the digital camera 1 are printed by the printer 2, is realized. On the other hand, in the case that the personal computer 3 operates as a USB host device, it becomes possible to view the images recorded in the memory card of the digital camera 1 at the personal computer 3, as will be described later.

The printer 2 operates both as a USB host device and as a USB function device. In the case that the printer 2 operates as a USB host device, the digital camera 1 becomes the function device, and the direct printing function is realized. On the other hand, in the case that the printer 2 operates as a USB function device, the personal computer 3 operates as the host device, to control the printer 2 as a USB printer.

The personal computer 3 always operates as a USB host device. As described above, the personal computer 3 views the images recorded in the memory card of the digital camera 1, and controls the printer 2 as a USB printer.

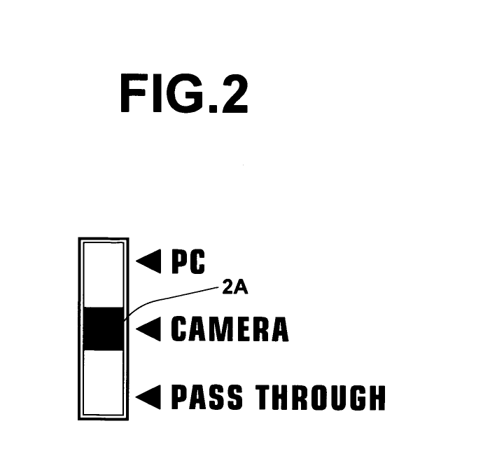

The printer 2 is equipped with a mode switch 2A for switching among the operating modes thereof. FIG. 2 is a plan view of the mode switch 2A. As shown in FIG. 2, the mode switch 2A is structured to be capable of switching among a PC connection mode (PC), a camera connection mode (CAMERA), and a pass through mode (PASS THROUGH). In the PC connection mode, the printer 2 and the personal computer 3 are connected to each other. In the camera connection mode, the printer 2 and the digital camera 1 are connected to each other. In the pass through mode, the digital camera 1 and the personal computer 3 are connected to each other. Note that FIG. 2 shows a state in which the mode switch 2A is in the camera connection mode.

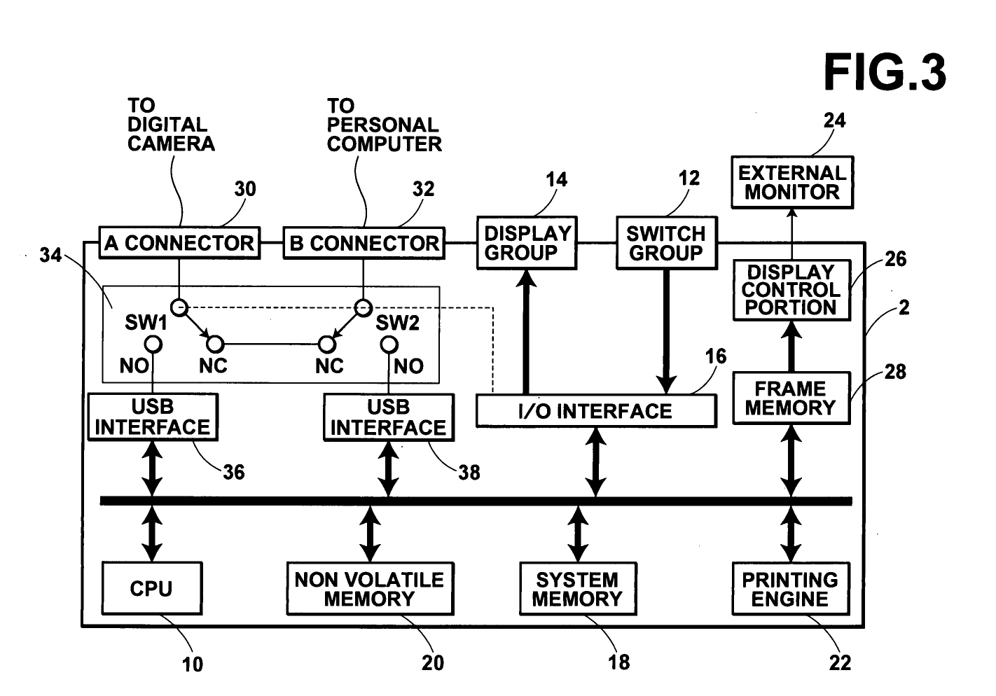

FIG. 3 is a block diagram of the signal processing system of the printer 2. The printer 2 comprises: a CPU 10 for controlling the entirety of the printer 2, readout of image data, printing, switching among modes, display and the like; a switch group 12 that includes the mode switch 2A; a display group 14; an input/output interface 16 for inputting settings for the switch group 12 and the display group 14; a system memory 18 constituting a ROM, in which programs and constants for the CPU 10 are stored, and a RAM, which serves as a workspace during execution of programs; a rewritable non-volatile memory 20 which is capable of recording various settings and constants of the printer 2 when it is turned off; a printing engine 22 for executing printing, constituting a printing head, a light source, a paper supply mechanism and the like; a display control portion 26 for performing D/A conversion on image data to display the image data at an external monitor 24, which is connected to the printer 2; and a frame memory 28 constituting a VRAM or the like, for temporarily storing image data to be displayed according to commands from the CPU 10.

The CPU 10 operates as a mode switching means by executing programs which are recorded in the system memory 18.

The printer 2 further comprises: an A connector 30, to which the first USB cable 5 for connecting to the digital camera 1 is connected; a B connector 32, to which the second USB cable 6 for connecting to the personal computer 3 is connected; a switch portion 34 for switching between signals from the A connector 30 and the B connector 32; a USB interface 36 for sending and receiving various types of data to and from the digital camera 1; and a USB interface 38 for sending and receiving various types of data to and from the personal computer 3.

The digital camera 1, which operates as a function device, is connected to the A connector 30 via the first USB cable 5. The personal computer 3, which operates as a host device, is connected to the B connector 32 via the second USB cable 6. Therefore, the shapes of the A connector 30 and the B connector 32 are different.

The switch portion 34 comprises a switch SW1 and a switch SW2. The CPU 10 detects the state of the mode switch 2A, and switches between the switches SW1 and SW2 via the input/output interface 16.

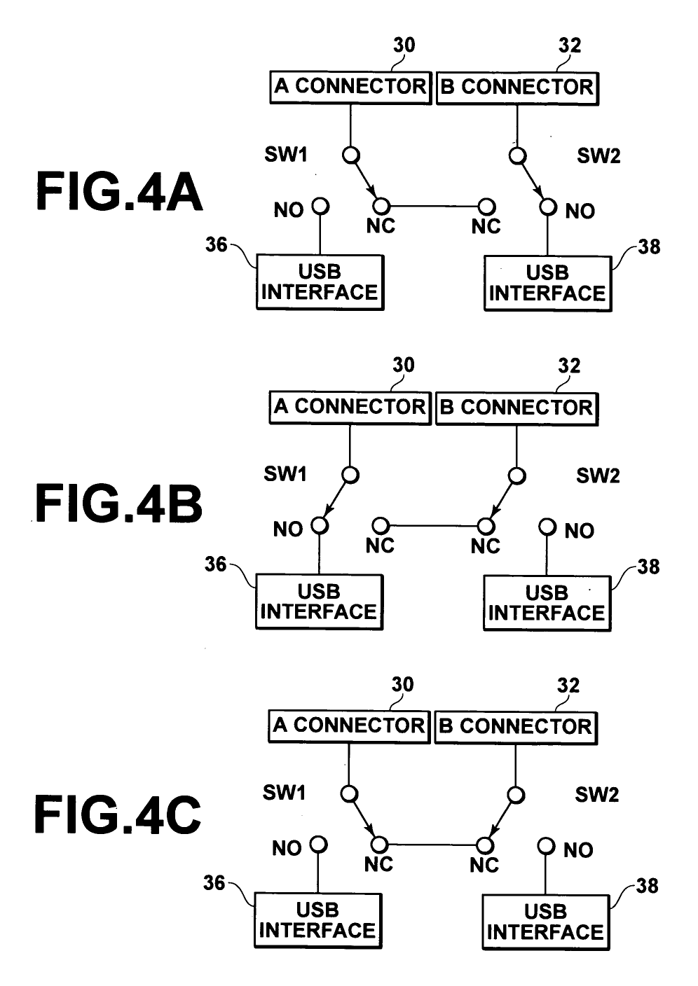

Here, in the case that the mode switch 2A is switched to the PC connection mode, the switch SW1 is switched to an NC side, and the switch SW2 is switched to an NO side, as shown in FIG. 4A. Thereby, the B connector 32 is connected to the USB interface 38, the printer 2 is connected to the personal computer 3, and operates as a USB function device.

In the case that the mode switch 2A is switched to the camera connection mode, the switch SW1 is switched to the NO side, and the switch SW2 is switched to the NC side, as shown in FIG. 4B. Thereby, the A connector 30 is connected to the USB interface 36, the printer 2 is connected to the digital camera 1, and operates as a USB host device, enabling the above described direct printing.

In the case that the mode switch 2A is switched to the pass through mode or the printer 2 is turned off, the switches SW1 and SW2 are both switched to the NC side, as shown in FIG. 4C. Thereby, the A connector 30 and the B connector 32 are connected to each other, and the printer 2 operates merely as a hub. In this state, a USB connection is established between the digital camera 1, which is connected to the A connector 30, and the personal computer 3, which is connected to the B connector 32.

As described above, a USB connection between the personal computer 3 and the digital camera 1, which are connected to the printer 2, is possible by simply switching the mode switch 2A, without disconnecting and reconnecting the USB cables 5 and 6.

In the present embodiment, the A connector 30 and the B connector 32 have different shapes. The connectors of the first USB cable 5 differ in shape at the end connected to the digital camera 1 and the end connected to the printer 2. Likewise, the connectors of the second USB cable 6 differ in shape at the end connected to the personal computer 3 and the end connected to the printer 2. Therefore, in the case that the first USB cable 5 and the second USB cable 6 are to be disconnected and reconnected, it becomes necessary to confirm the shapes of the connectors, causing the operation to be extremely troublesome. However, according to the present embodiment, the need to disconnect and reconnect the first and second USB cables 5 and 6 is obviated. Therefore, the need to confirm the shapes of the connectors is obviated, even in the case that the shapes of the connectors of the first and second USB cables 5 and 6 differ.

Meanwhile, when the printer 2 is turned off, the switches SW1 and SW2 are both switched to the NC side, to establish a connection between the A connector 30 and the B connector 32. Thereby, even if the printer 2 is turned off, a USB connection is established between the digital camera 1, which is connected to the A connector 30, and the personal computer 3, which is connected to the B connector 32. Therefore, the personal computer 3 and the digital camera 1 can be connected without turning the printer 2 on, which saves electricity.

Note that in the embodiment described above, the digital camera 1 and the personal computer 3 are connected to the printer 2, which operates as both a host device and a function device. It is also possible to connect another apparatus that operates as both a host device and a function device.

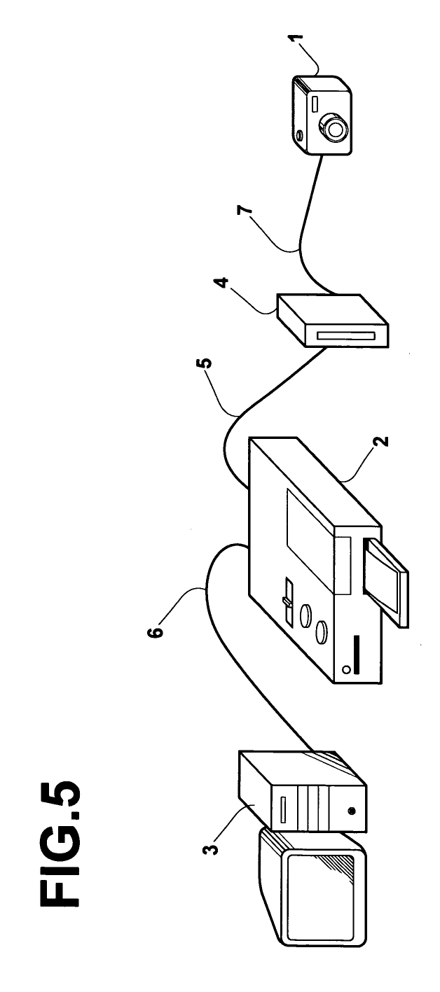

FIG. 5 is a schematic view of a printing system, which is a modification of the printing system of FIG. 1. In the printing system of FIG. 5, an Magneto Optical (MO) disk drive 4 is connected to the printer 2 instead of the digital camera 1, and the digital camera 1 is connected to the MO drive 4 via a third USB cable 7. The MO drive 4 is configured to be switched among a camera connection mode, a printer connection mode and a pass through mode. In the camera connection mode, the MO drive 4 connects to the digital camera 1 to record image data, recorded in the memory card thereof, in an MO disk in the MO drive 4. In the printer connection mode, the MO drive 4 causes image data recorded therein to be printed by the printer 2. Further, the MO drive 4 is configured so that the operating mode is switched to the pass through mode when it is turned off.

Note that viewing of images recorded in the MO disk of the MO drive 4 at the personal computer 3 is enabled by turning the printer 2 off, or switching the operating mode of the printer 2 to the pass through mode.

Therefore, even if the MO drive 4 is interposed between the printer 2 and the digital camera 1, USB connections can be established between the printer 2 and the digital camera 1, the personal computer 3 and the MO drive 4, and the personal computer 3 and the digital camera 1, without disconnecting and reconnecting the first through third USB cables 5, 6, and 7.

Note that in the embodiments described above, the digital camera 1, the printer 2, the personal computer 3 and the MO drive 4 are connected by the first through third USB cables 5, 6, and 7. However, the present invention is not limited to that which employs the USB standard, and any connection format may be employed.

What is claimed is:

1. A host/function apparatus that operates as both a host device and a function device, comprising:
a first connector, to which a host device is connected via a first cable;
a second connector, to which a function device is connected via a second cable; and
a mode switching means for switching operating modes among a host mode, in which the apparatus operates as a host device, a function mode, in which the apparatus operates as a function device, and a pass through mode, in which the first connector and the second connector are connected.

2. A host/function apparatus as defined in claim 1, wherein:
the mode switching means switches to the pass through mode when the host/function apparatus is turned off.

3. A host/function apparatus as defined in claim 1, wherein:
the shapes of the first connector and the second connector differ.

4. A host/function apparatus as defined in claim 2, wherein:
the shapes of the first connector and the second connector differ.

5. A host/function apparatus as defined in claim 3, wherein:
the first connector and the second connector are USB connectors.

6. A host/function apparatus as defined in claim 4, wherein:
the first connector and the second connector are USB connectors.

7. A host/function apparatus as defined in claim 1, wherein:
the host device is a data processing device;
the function device is a digital camera; and
the host/function apparatus further comprises an output means for printing images according to commands from the data processing device, as well as for printing images recorded in the digital camera.

8. A host/function apparatus as defined in claim 2, wherein:
the host device is a data processing device;
the function device is a digital camera; and
the host/function apparatus further comprises an output means for printing images according to commands from the data processing device, as well as for printing images recorded in the digital camera.

9. A host/function apparatus as defined in claim 3, wherein:
the host device is a data processing device;
the function device is a digital camera; and
the host/function apparatus further comprises an output means for printing images according to commands from the data processing device, as well as for printing images recorded in the digital camera.

10. A host/function apparatus as defined in claim 4, wherein:
the host device is a data processing device;
the function device is a digital camera; and
the host/function apparatus further comprises an output means for printing images according to commands from the data processing device, as well as for printing images recorded in the digital camera.

11. A host/function apparatus as defined in claim 5, wherein:
the host device is a data processing device;
the function device is a digital camera; and
the host/function apparatus further comprises an output means for printing images according to commands from the data processing device, as well as for printing images recorded in the digital camera.

12. A host/function apparatus as defined in claim 6, wherein:
the host device is a data processing device;
the function device is a digital camera; and
the host/function apparatus further comprises an output means for printing images according to commands from the data processing device, as well as for printing images recorded in the digital camera.
